(19) United States
(12) Patent Application Publication
(10) Pub. No.: US 2014/0344768 A1
(43) Pub. Date: Nov. 20, 2014

(54) METHOD OF APPLYING A HANDWRITING SIGNAL TO ACTIVATE AN APPLICATION

(71) Applicant: Yi Hau Su, New Taipei City (TW)

(72) Inventor: Yi Hau Su, New Taipei City (TW)

(21) Appl. No.: 14/281,900

(22) Filed: May 20, 2014

(30) Foreign Application Priority Data
May 20, 2013 (TW) 102117839

(51) Int. Cl. G06F 3/0488

(52) U.S. Cl. CPC G06F 3/04883
USPC 715/863

(57) ABSTRACT

A method for activating an application by applying a handwriting signal is provided herein, which input the handwriting signal to a touch device where the activation of the application is called. The method includes the steps of: providing a handwriting signal to a handwriting recognition process; outputting a recognition signal from the handwriting recognition process; and activating the application by an operation system (OS) according to the recognition signal.

### BACKGROUND OF THE INVENTION

1. Field of Invention

The present invention relates to a method for activating an application which is a combination of handwriting recognition technology and activating an application from an Operation System (OS).

2. Description of Prior Art

Touch devices including, for example, smart phones, tablets and touch HMI (Human Machine Interface) devices, an application running or data activating of which is performed by clicking an icon, along with PCs. When a touch device is installed with a plurality of applications or data, it takes time to search the icons which needs to be clicked by a user's finger to activate the corresponding applications or the data.

Operation system (OS), e.g. iOS, Android, Mango, for general touch devices allows an user manage its applications and data by sorting in group, in order to save several time of searching application icons or data. Once the number of applications or the amount of data becomes excessive, users need to manage them with multi-layer groups so that it takes more time to search the icons of the applications or data. Since the OS of the general touch device has a search engine built therein, users can input a key word on a column of the search engine, then the icon and its information corresponding to the application or data can be found, and the searching time is greatly shortened.

To search the icon and its information corresponding to the application or data with the search engine, users need to input a key word by typing, handwriting recognition, or voice recognition. Then, the search engine can filter the applications and data one by one based on the key word. General touch devices are not equipped with a physical keyboard and the space provided for handwriting input is small, so it is inconvenient to type or write by hand. If users input key words by voice recognition, then background noise or similar pronunciation can easily cause problems, so in practice voice recognition is used far less than typing or handwriting recognition. Thus, with the prior art, the major method for solving the above problem is using an external keyboard.

### SUMMARY OF THE INVENTION

The invention provides a method of activating an application by applying a handwriting signal which is inputted to a touch device where activation of the application is called. The method comprises the following steps of: providing the handwriting signal to a handwriting recognition process, outputting a recognition signal from the handwriting recognition process, and activating the application by an operation system according to the recognition signal. The purpose of the present invention is used to change a search method for an icon of an application or data and information about the application or data, and allows users to more directly and rapidly choose an application or data inside the touch device.

General touch devices usually adopt PC clicking methods to run applications or open data, but hand touching is less exactly than mouse clicking Touch devices and PCs use keyboards as the inputting interface when inputting, and the size of a virtual keyboard of a touch device is smaller than a physical keyboard. Thus, handwriting recognition and voice recognition has become assistive inputting equipment for touch devices, but handwriting recognition and voice recognition are less efficient than physical keyboards, which in turn influences the search engine of the OS.

The purposes of the present invention are to solve occurrence of the efficiency problems upon usage of a search engine with the present handwriting recognition method in a touch device, instead of designing a new searching method for applications or data, which increases the usage efficiency of the applications or data. An original thoughtfulness of the present invention is to treat the touch device as an all-mighty magic box wherein the touch device becomes a functional device with a simple command input. For example, the magic box can become a music player if user wishes, or the magic box becomes a communication device if user wishes, or the magic box becomes an on-line shopping device on the user's demand. Thus the present invention creates a method to activate the application by a handwriting signal.

### BRIEF DESCRIPTION OF THE DRAWINGS

FIG. 1 shows a drawing of a method applying a handwriting signal to activate an application;

FIG. 2 shows a flow chart of the method according to the present invention;

FIG. 3 shows a flow chart of the sub-steps of the method according to the present invention.

FIG. 4 shows a clicking motion of a user's finger on a selection and conversation box.

FIG. 5 shows a handwriting orbit which is inputted to a camera module by a user's finger.

### DETAILED DESCRIPTION OF THE PREFERRED EMBODIMENTS

The method to complete the present invention will be described by at least one specific embodiment as follow, which will allow a person familiar with the art to easily understand the other advantages and effects of the present invention presented by the specification of the present invention. Without departing from the foundation of the innovative spirit of the present invention, each embodiment of the present invention can also be modified and changed, or by the realization or applied to different embodiments which are not disclosed in the specification of the present invention. In addition, the details of the embodiments of the present invention could be applied in other applications based on a variety of different points of view.

As mentioned above, a method according to the present invention comprises the steps: providing a handwriting signal to a handwriting recognition process; outputting a recognition signal from the handwriting recognition process; and activating an application by an OS according to the recognition signal. FIG. 1 shows a method of applying a handwriting signal to activate an application. A finger 20 inputs a handwriting orbit 21 on a touch screen 11 of a touch device 10, the touch screen 11 detects the handwriting orbit 21 and generates a handwriting signal.

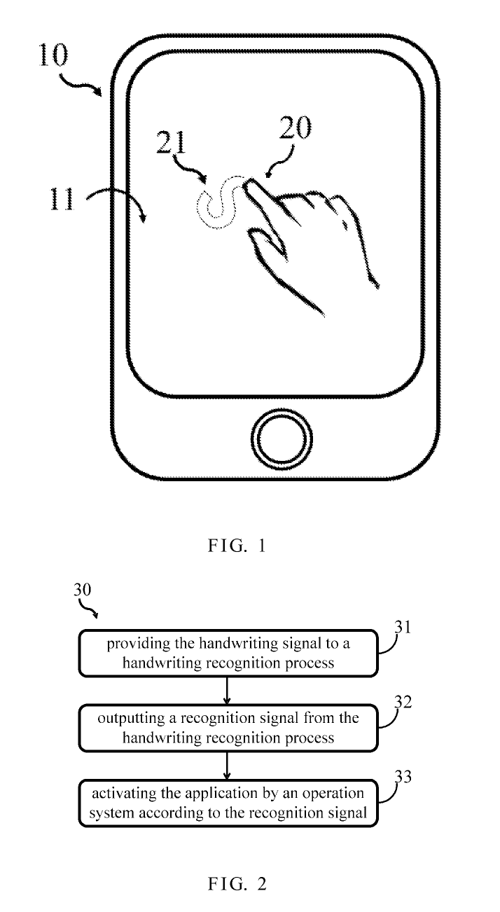

FIG. 2 shows a flow chart of the method according to the present invention. Process 30 which is the method for applying a handwriting signal to start an application, the process 30 comprises the steps: step 31: providing a handwriting signal to a handwriting recognition process; step 32: outputting a recognition signal from the handwriting recognition process; step 33: activating an application by an OS according to the recognition signal. The handwriting signal is generated by the handwriting orbit 21 of the touch screen 11 of FIG. 1. Referring to FIG. 1 and FIG. 2, the handwriting orbit 21 could be a symbol, a character, a string composited of symbols, and characters, or a simple geometric pattern data, so that the handwriting signal comprises data of the symbol, the character, the string composited of symbols and characters, or the simple geometric pattern. In step 31 and step 32, the handwriting signal is processed by a core processor inside the touch device 10 by a handwriting recognition process. Finally, the recognition signal is generated, and the step 33 is processed. The method of the present invention of applying a handwriting signal to activate an application is further described with following embodiments.

The first embodiment is referred to FIG. 1, in which a user's finger 20 inputs a handwriting orbit 21 on a touch screen 11 of a touch device 10, and the handwriting signal 21 is an orbit of “@”. The touch screen 11 detects the handwriting orbit 21 and outputs the handwriting signal. FIG. 2 shows the process 30 of the present invention which comprises: step 31: providing a handwriting signal to a handwriting recognition process; step 32: outputting a recognition signal from the handwriting recognition process; step 33: activating an application by an OS according to the recognition signal. The recognition signal is decoded as a symbol “@”, which activates the OS to activate an e-mail application. The result of the first embodiment is as follows: user uses their finger 20 to draw a handwriting orbit 21 (a symbol “@”), and the touch device 10 activates the e-mail application immediately.

Furthermore, in step 33, the step is performed with utilization of an onto-function on making the recognition signal onto one or multiple applications. Then, the OS correctly calls activation of the application. In the first embodiment, as FIG. 1 shows, the OS of the touch device 10 is operated in standby and power saving mode, and the touch screen 11 keeps a detecting mode and shut down a back light module. Once the handwriting orbit 21 is detected by the touch screen 11, the application is immediately activated by the OS with the process as shown in FIG. 2, the back light module of the touch device 10 is activated, and the standby and power saving mode is terminated. A process to unlock the screen of the touch device 10 or to change the operation mode is mentioned above. The content mentioned above could be applied in other embodiments.

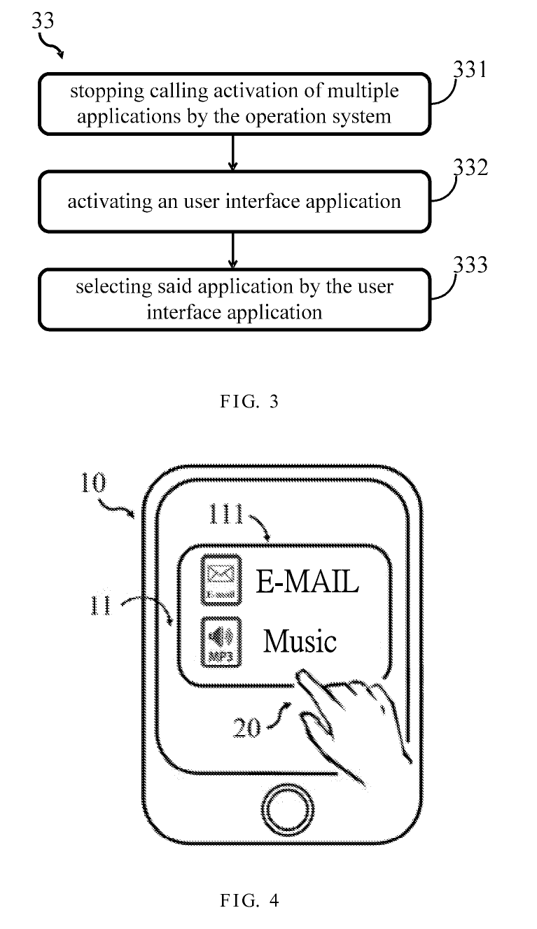

The second embodiment is shown in FIG. 1 and FIG. 2. The words MUSIC and MAIL both start with M. In a system of a touch device 10, a single letter M represents both E-mail and Music, and a handwriting orbit 21 is inputted on the touch screen 11 of the touch device 10 by a user's finger 20. The handwriting orbit 21 is an orbit of “M” or “m”, and a handwriting signal is outputted after being detected by the touch screen 11. FIG. 2 shows the process 30 of the present invention which comprises: step 31: providing a handwriting signal to a handwriting recognition process; step 32: outputting a recognition signal from the handwriting recognition process; step 33: activating an application by an OS according to the recognition signal. In step 33, step 33 is performed with utilization of an onto-function on making the OS correctly calls activation of the application. When the recognition signal is decoded as a single letter “M” or “m”, the recognition signal is being onto two applications (an E-mail application and a Music application), and the OS needs to call and activate an E-mail application and a Music application at the same time. In order to prevent multiple applications from being called by the OS by the onto-function at the same time, as FIG. 3 shows, step 33 further comprises sub-steps: sub-step 331: stopping calling activation of the multiple applications by the OS; sub-step 332: activating an user interface application; sub-step 333: selecting said application by the user interface application. In the second embodiment, the OS activates sub-step 331 to stop the E-mail application and the Music application from being activated at the same time. FIG. 4 is an operational performance on the touch device 10 of sub-step 332, and a selection-conversation box 111 labeled with characters and icons of the E-mail application and the Music application is shown by the user interface application. In sub-step 333, the user's finger 20 clicks the application needing to be activated in the selection-conversation box 111. Then, the OS calls activation of the application by the user interface application. The performance of the second embodiment shows: the user's finger 20 inputs a handwriting orbit 21 of “M” or “m” on the touch screen 11 of the touch device 10, the touch screen 11 shows a selection-conversation box 111 labeled with characters and icons of the E-mail application and the Music application, an user's finger 20 clicks on the selection-conversation box 111, informing the touch device 10 whether to activate an E-mail application or a Music application.

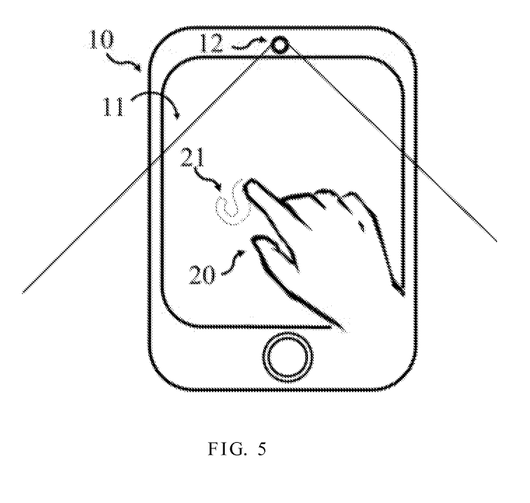

The third embodiment is showed in FIG. 5 and FIG. 2. A touch device 10 comprises a touch screen 11 and a camera module 12. The first letter of the word Tool is T, a single letter “T” represents an application about tools in a system of the touch device 10. A user's finger 20 inputs a handwriting orbit 21 in the range inside of a viewing range of the camera module 12 without touching the touch screen 11. The handwriting orbit 21 is a letter “T” or “t”, the camera module 12 detects the handwriting orbit 21 and generates a handwriting signal. As FIG. 2 shows, the handwriting signal is inputted to the process 30, a recognition signal is decoded as a letter “T” or “t”, and the touch device 10 activates a tool application or a tool management application. Please refer to the first and second embodiments for the detailed steps. As mentioned above, the camera module 12 detects the handwriting orbit 21, which is completed by high speed continuous shooting of the finger 20 with the camera module 12. An image comparison operation processing is performed by a core processor inside the touch device 10, determining the data of the handwriting orbit 21 to generate the handwriting signal. The result of the third embodiment shows the tool application or the tool management application is displayed on the touch screen 11 of the touch device 10 when the user's finger inputs a handwriting orbit 21 as “T” or “t” to the camera module 12 without touching the touch screen 11.

The forth embodiment is as shown in FIG. 1 and FIG. 2, or FIG. 5 and FIG. 2. A user's finger 20 inputs a handwriting orbit 21 on a touch device 10. The handwriting orbit 21 is a string “TV” or “tv” or “Tv” or “tV”, the string “TV” or “tv” or “Tv” or “tV” all represents a multi-media playback application in a system of a touch device 10. A handwriting signal is outputted after being detected by a touch screen 11 or a camera module 12. FIG. 2 shows the process 30 of the present invention which comprises: step 31: providing a handwriting signal to a handwriting recognition process; step 32: outputting a recognition signal from the handwriting recognition process; step 33: activating an application by an OS according to the recognition signal. Finally, the recognition signal is decoded as a string “TV” or “tv” or “Tv” or “tV”, and the OS calls activation of a multi-media playback application. The result of the fourth embodiment is as follows: a user's finger 20 draws handwriting orbit 21 as a string “TV” or “tv” or “Tv” or “tV”, and the touch screen of the touch device 10 displays a multi-media playback application.

The fifth embodiment is as shown in FIG. 1 and FIG. 2, or FIG. 5 and FIG. 2. A user's finger 20 inputs a handwriting orbit 21 “MAIL” on the touch device 10. The handwriting orbit 21 is a simple geometric pattern data “ [symbol] ”, the simple geometric pattern data “ [symbol] ” represents string “MAIL” which is also related to E-mail, the hand writing signal is outputted after being detected by a touch screen 11 or a camera module 12. FIG. 2 shows the process 30 of the present invention which comprises: step 31: providing a handwriting signal to a handwriting recognition process; step 32: outputting a recognition signal from the handwriting recognition process; step 33: activating an application by an OS according to the recognition signal. Finally, the recognition signal is decoded as a string “MAIL”, and the OS calls activation of an E-mail application. The result of the fifth embodiment is as follows: a user's finger 20 inputs the handwriting orbit 21, the handwriting orbit 21 is a simple geometric pattern data “ [symbol] ”, and the touch screen of the touch device 10 shows an E-mail application.

In addition, as described from embodiments 1-5, the relationship between each handwriting orbit 21 and each application is defined in advance, for example, a handwriting orbit 21 as a letter “G” or “g” is meant to ask the OS to activate a game or its management application, a handwriting orbit 21 as a letter “M” or “m” or “ [symbol] ”is meant to ask the OS to activate an music application; or even a handwriting orbit as “X” or “x” or “\” or “/” is meant to ask the OS to shut down the present application. What is mentioned above is meant to describe the method of applying a handwriting signal to activate an application. A user could freely setup a connection between each handwriting orbit and each application, and the user could quickly activate the desired application with what is mentioned above. Finally, the process 30 could be coded as system software with existing programming language and equipped with existing handwriting recognition technology and image recognition technology, to complete the main purpose of the present invention.

The embodiments mentioned above are described the principle and effects of the present invention and the applications of parts of the embodiments, but are not intended to limit the present invention. Those of ordinary skill in the art, without departing from the spirit and scope of the present invention, can make various kinds of modifications and variations to the present invention. Therefore, the scope of the claims of the present invention must be defined as the claims mention later.

What is claimed is:

1. A method for activating an application by applying a handwriting signal which is inputted to a touch device where activation of the application is called, the method comprising the following steps of:
providing the handwriting signal to a handwriting recognition process;
outputting a recognition signal from the handwriting recognition process; and
activating the application by an operation system according to the recognition signal.

2. The method according to claim 1, wherein the handwriting signal comprises a symbol, a character, a string composited of symbols and characters, or a simple geometric pattern data.

3. The method according to claim 1, wherein the step of activating the application by the operation system according to the recognition signal is performed with utilization of an onto-function on making the recognition signal onto one or multiple applications so that the operation system correctly calls activation of the application.

4. The method according to claim 3, wherein the step of utilizing the onto-function on making the recognition signal onto one or multiple applications so that the operation system correctly calls activation of the application further comprises the following sub-steps:
stopping calling activation of the multiple applications by the operation system;
activating an user interface application;
selecting said application by the user interface application.

5. The method according to claim 1, wherein the touch device further comprises a camera module via which the handwriting signal is inputted to the touch device.

6. The method according to claim 5, wherein the handwriting recognition process is a handwriting image recognition process.

7. The method according to claim 1, wherein the method is treated as a substitute to unlock the touch device or change an operation mode thereof.

8. The method according to claim 6, wherein the method is treated as a substitute to unlock the touch device or change an operation mode thereof.
